(19) United States
(12) Patent Application Publication
(10) Pub. No.: US 2015/0185943 A1
(43) Pub. Date: Jul. 2, 2015

(54) TOUCH CONTROL DISPLAY PANEL AND CONTROL CIRCUIT THEREOF

(71) Applicants: Shanghai Tianma Micro-Electronics Co., Ltd., Shanghai (CN); Tianma Micro-Electronics Co., Ltd., Shanghai (CN)

(72) Inventors: Lin Wen, Shanghai (CN); Hong Li, Shanghai (CN); Conghua Ma, Shanghai (CN); Shuai You, Shanghai (CN)

(21) Appl. No.: 14/586,768

(22) Filed: Dec. 30, 2014

(30) Foreign Application Priority Data
Dec. 30, 2013 (CN) 201310747274.2

(51) Int. Cl. G06F 3/041; G09G 3/36; G06F 3/044

(52) U.S. Cl. CPC G06F 3/0412; G06F 3/044; G09G 3/3648

(57) ABSTRACT

A control circuit of a touch display panel is disclosed. The control circuit includes a data signal source, a plurality of data signal lines, and a first control circuit. A scan period of the touch display panel includes a display period and a touch scan period. The first control circuit is configured to connect the data signal lines with the data signal source during the display period, and the first control circuit is configured to disconnect the data signal lines from the data signal source during the touch scan period.

This application claims the benefit of priority to Chinese Patent Application No. 201310747274.2, filed with the Chinese Patent Office on Dec. 30, 2013 and entitled “TOUCH DISPLAY PANEL AND CONTROL CIRCUIT THEREOF”, the content of which is incorporated herein by reference in its entirety.

### BACKGROUND OF THE INVENTION

Touch display screens have gradually become popularized in the life of people along with rapid development of display technologies. At present the touch display panels can be structurally categorized into add-on mode touch panels, on-cell touch panels and in-cell touch panels. The touch electrodes of the in-cell touch panels embedded in liquid crystal display panels can lower the overall thickness of modules and also lower a cost of manufacturing the touch panels and thus have become favored by various panel manufacturers.

At present, a capacitive in-cell touch display panel is produced by adding touch driving lines and touch sensing lines on an existing Thin Film Transistor (TFT) array substrate and operates as follows: after a frame of display picture is scanned for display, a touch driving signal is applied to the touch driving lines for touch scanning, and voltage signals coupled-output from the touch sensing lines through inductive capacitors are detected, and in this process, when there is a human body contacting the touch panel, an electric field of the human body will affect inductive capacitor to thereby change a capacitance value of the inductive capacitor and further change a voltage signal coupled-output from some touch sensing lines, and a touch location can be determined from the change in voltage signal.

With the existing capacitive in-cell touch display panel, each frame of display picture is driven by applying a display driving signal continuously by a data signal source to data signal lines and also applying the display driving signal to TFTs in a display area, so touch scanning has to be performed after each frame of display picture is driven for display, but there is a short interval between frames, so the duration of touch scanning is also limited, thus lowering the number of determined touch points and degrading the precision of determining the touch location.

### BRIEF SUMMARY OF THE INVENTION

One inventive aspect is a control circuit of a touch display panel. The control circuit includes a data signal source, a plurality of data signal lines, and a first control circuit. A scan period of the touch display panel includes a display period and a touch scan period. The first control circuit is configured to connect the data signal lines with the data signal source during the display period, and the first control circuit is configured to disconnect the data signal lines from the data signal source during the touch scan period.

Another inventive aspect is a touch display panel, including a control circuit. The control circuit includes a data signal source, a plurality of data signal lines, and a first control circuit. A scan period of the touch display panel includes a display period and a touch scan period. The first control circuit is configured to connect the data signal lines with the data signal source during the display period, and the first control circuit is configured to disconnect the data signal lines from the data signal source during the touch scan period.

### BRIEF DESCRIPTION OF THE DRAWINGS

The drawings described here are intended to provide further understanding of the invention and constitute a part of the invention but not limit the invention. In the drawings:

FIG. 1 is a schematic structural diagram of a control circuit of a touch display panel according to an embodiment of the disclosure;

FIG. 2 is a schematic structural diagram of another control circuit of a touch display panel according to an embodiment of the disclosure;

FIG. 3 is a schematic diagram of a particular structure of a control circuit of a touch display panel according to an embodiment of the disclosure;

FIG. 4A is a timing diagram of pulse signals provided by a first signal source and a second signal source according to an embodiment of the disclosure;

FIG. 4B is a comparative diagram of timings of a display drive signal in the related art, and a display drive signal according to an embodiment of the disclosure, in a period of one frame;

FIG. 5 is a schematic diagram of a control circuit, including an inverter, of a touch display panel according to an embodiment of the disclosure;

FIG. 6 is a schematic diagram of a structure of a control circuit including a trigger circuit, of a touch display panel according to an embodiment of the disclosure;

FIG. 7 is a schematic structural diagram of a touch display panel including a first control circuit and a second control circuit according to an embodiment of the disclosure;

FIG. 8A and FIG. 8B are schematic diagrams of a structure of a control circuit of a touch display panel in a simplified circuit structure according to an embodiment of the disclosure; and

FIG. 9 is a schematic diagram a structure of a touch display panel according to an embodiment of the disclosure.

### DETAILED DESCRIPTION OF THE PREFERRED EMBODIMENTS

The technical solutions according to the embodiments of the disclosure will be described clearly and fully below with reference to the drawings in the embodiments of the disclosure, and apparently the described embodiments are only a part but not all of embodiments of the disclosure. Any other embodiments which can occur to those ordinarily skilled in the art based upon the described embodiments of the disclosure and without any inventive effort shall come into the claimed scope of the disclosure.

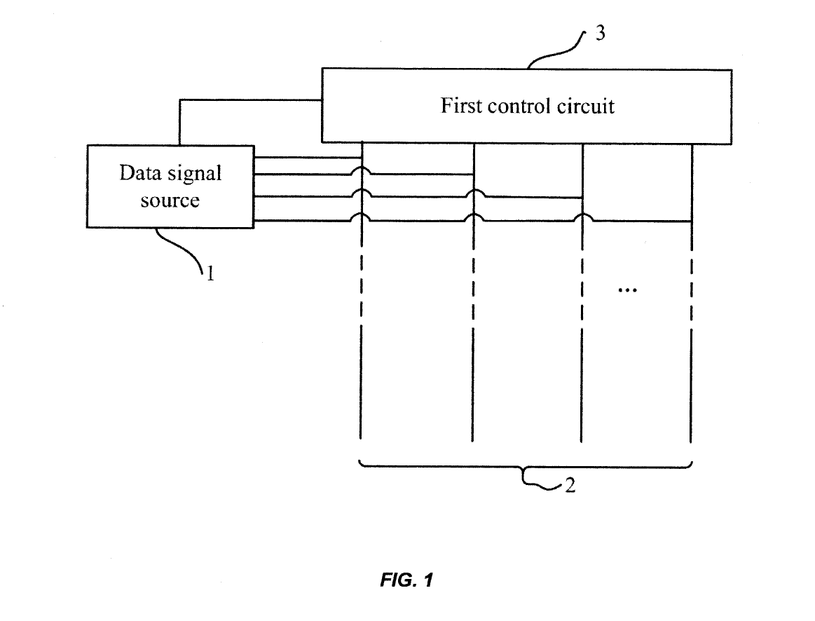

An embodiment of the disclosure provides a control circuit of a touch display panel, and FIG. 1 illustrates a schematic structural diagram of a control circuit of a touch display panel according to an embodiment of the disclosure.

As illustrated in FIG. 1, the control circuit of a touch display panel according to the embodiment of the disclosure includes a data signal source 1, data signal lines 2 and a first control circuit 3.

Specifically in the embodiment of the disclosure, a scan period of the touch display panel includes a display period and a touch scan period, where in the display period, the first control circuit 3 connects the data signal lines 2 with the data signal source 1, and the data signal source 1 applies a display drive signal to the touch display panel through the data signal lines 2 to drive a display picture for display.

Furthermore in the embodiment of the disclosure, the first control circuit 3 is further configured to disconnect the data signal lines 2 from the data signal source 1 in the touch scan period. Stated otherwise, in the embodiment of the disclosure, during the display period in which the display picture was ever driven for display, the display drive signal can be stopped from being applied to the touch display panel by the data signal source 1 so as to stop the display picture from being driven for display, and touch driving signal can be applied to touch driving lines for touch scanning Thus, the touch scan period can be arranged in the period in which driving for display was initially performed, and it is not necessary to perform touch scanning only after one frame has been scanned.

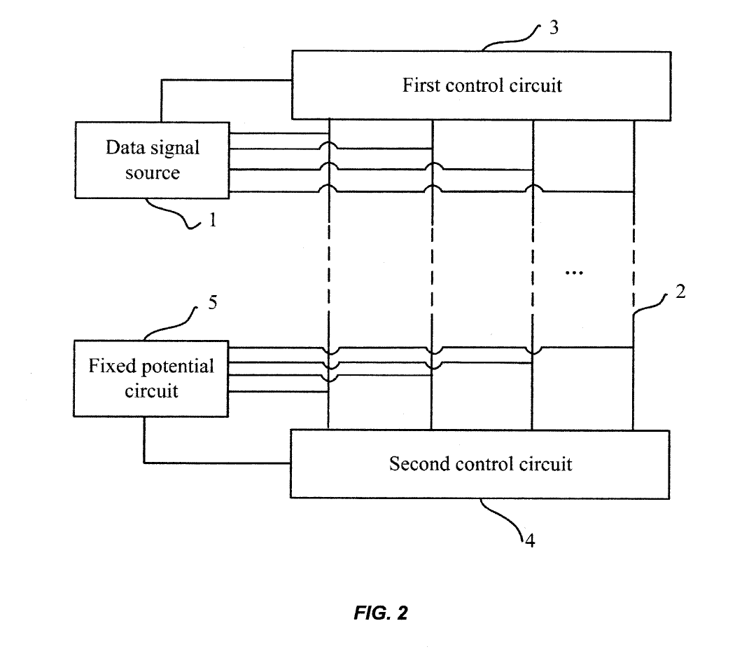

Optionally in the embodiment of the disclosure, the control circuit of a touch display panel further includes a second control circuit 4 and a fixed potential circuit 5, and FIG. 2 illustrates a schematic diagram of a structure of another control circuit of a touch display panel according to an embodiment of the disclosure.

Specifically in the embodiment of the disclosure, the data signal source 1 is stopped by the first control circuit 3 from applying the display drive signal to the touch display panel, and after the first control circuit 3 disconnects the data signal lines 2 from the data signal source 1, the data signal lines 2 will float, and the floating data signal lines 2 may tend to result in parasitic capacitances which will influence the touch scan drive signal for touch scanning, so in the embodiment of the disclosure, in order to alleviate the influence of the resultant parasitic capacitances on the touch scan drive signal, the data signal lines can be connected onto a circuit at a fixed potential. In this way, a fluctuating signal can be prevented from being generated by the data signal lines, and in the embodiment of the disclosure, the fixed potential circuit 5 is connected with the data signal lines 2, and in the embodiment of the disclosure, the fixed potential circuit 5 can be a circuit at a fixed potential in an original control circuit inside the panel or can be a newly added circuit; and in the embodiment of the disclosure, the fixed potential circuit 5 may be a grounded circuit in order to completely avoid varying potentials on the data signal lines.

In the embodiment of the disclosure, the second control circuit 4 is configured to disconnect the data signal lines 2 from the fixed potential circuit 5 in the display period; and the second control circuit 4 is configured to connect the data signal lines 2 with the fixed potential circuit in the touch scan period.

Furthermore in the embodiment of the disclosure, the first control circuit 3 includes several first transistors 301 connected respectively with the respective data signal lines 2 and a first signal source 302 applying a pulse signal to the first transistors 301. The second control circuit 4 includes several second transistors 401 connected respectively with the respective data signal lines 2 and a second signal source 402 applying a pulse signal to the second transistors 401.

Specifically in the embodiment of the disclosure, in order to make it easy to add the first transistors 301 and the second transistors 401 to a display circuit of the touch display panel, low-temperate poly-silicon thin film transistors or oxide thin film transistors with high electron mobility can be used.

As experimentally evidenced, a low-temperate poly-silicon thin film transistor fabricated with the technology of Low Temperature Poly-Silicon (LTPS) has the highest electron mobility and the lowest conduction resistance. A poly-silicon thin film transistor fabricated in an a-Si (poly-silicon) process has the lowest electron mobility and the highest conduction resistance, where the conduction resistance of a-si is 500 times that of low-temperate poly-silicon fabricated in an LTPS process. The electron mobility of an oxide thin film transistor lies between that of low-temperate poly-silicon and that of poly-silicon, for example, the conduction resistance of an indium gallium zinc oxide thin film transistor fabricated of the Indium Gallium Zinc Oxide (IGZO) material is 10 times that of low-temperate poly-silicon fabricated in an LTPS process. Thus in the embodiment of the disclosure, low-temperate poly-silicon thin film transistors or oxide thin film transistors with high electron mobility can be used for the first transistors and the second transistors.

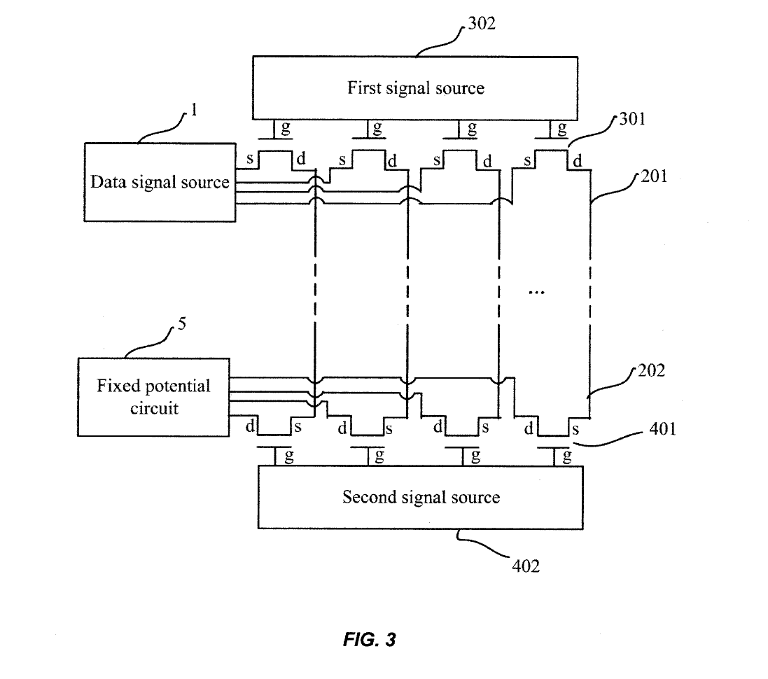

FIG. 3 illustrates a schematic diagram of a particular structure of a control circuit of a touch display panel according to an embodiment of the disclosure.

In FIG. 3, each first transistor 301 has a gate g connected with the first signal source 302, a source s connected with an output end of the data signal source 1, and a drain d connected with a first end 201, proximate to the data signal source 1, of the data signal line 2. Each second transistor 401 has a gate g connected with the second signal source 402, a source s connected with a second end 202, away from the data signal source 1, of the data signal line 2, and a drain d connected with the fixed potential circuit 5.

In the embodiment of the disclosure, the first control circuit 3 includes the first transistors 301 and the first signal source 302, and the second control circuit 4 includes the second transistors 401 and the second signal source 402. In the embodiment of the disclosure, in the first control circuit 3, a pulse signal is applied to the first transistors 301 by the first signal source 302, and the first transistors 301 are controlled by the pulse signal to be turned on and off so that the data signal lines 2 are connected with or disconnected from the data signal source 1.

Alike in the second control circuit 4, a pulse signal is applied to the second transistors 401 by the second signal source 402, and the first transistors 401 are controlled by the pulse signal to be turned on and off so that the data signal lines 2 are connected with or disconnected from the fixed potential circuit 5.

In the embodiment of the disclosure, the first transistors 301 and the second transistors 401 can be N-type transistors or can be P-type transistors, where the N-type transistors are turned on by a pulse signal at a high level and turned off by a pulse signal at a low level, and the P-type transistors are turned on by a pulse signal opposite in phase opposite to a pulse signal by which the N-type transistors are turned on, and the embodiment of the disclosure will be described taking as an example the first transistors 301 and the second transistors 401, both of which are N-type transistors but will not be limited thereto.

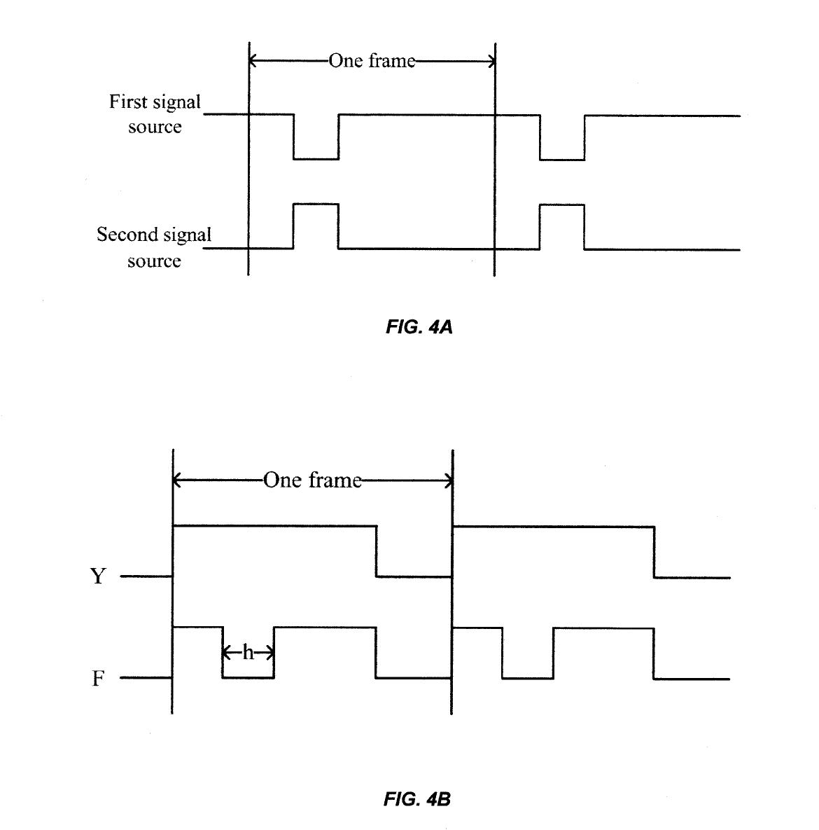

FIG. 4A is a timing diagram of pulse signals provided by the first signal source 302 and the second signal source 402 according to the embodiment of the disclosure.

In the display period, the first signal source 302 applies a pulse signal at a high level to the first transistors 301 so that the first transistors 301 are turned on. In this way, the data signal lines 2 are connected with the data signal source 1, resulting that the data signal source applies a display drive signal to the touch display panel for display driving. The second signal source 402 applies a pulse signal at a low level to the second transistors 401 so that the second transistors 401 are turned off. In this way, the data signal lines 2 are disconnected from the fixed potential circuit 5.

In the touch scan period, the first signal source 302 applies a pulse signal at a low level to the first transistors 301 so that the first transistors 301 are turned off. In this way, the data signal lines 2 are disconnected from the data signal source 1, resulting that the display drive signal is stopped from being applied to the touch display panel by the data signal source so as to stop driving for display. The second signal source 402 applies a pulse signal at a high level to the second transistors 401 so that the second transistors 401 are turned on. In this way, the data signal lines 2 are connected with the fixed potential circuit 5, resulting that the potential of the data signal lines 2 will not be changed, thus alleviating an influence arising from parasitic capacitances.

FIG. 4B illustrates a comparative diagram of timings of a display drive signal Y in the related art, and a display drive signal F according to an embodiment of the disclosure, in a frame. As can be apparent from FIG. 4B, in the originally continuous display drive period, an idle period h can be arranged in that continuous display drive period according to the disclosure, where the idle period h can be configured for touch scanning, and the length of time of the idle period h and the number thereof can be controlled flexibly dependent upon the touch scan period as desired in practice. In this way, the number of determined touch points can be increased and the precision at which a touch location is determined can be increased.

Furthermore as can be apparent from the timing diagram in FIG. 4, the pulse signal waveforms provided by the first signal source 302 is opposite in phase with that provided by the second signal source 402, so in the embodiment of the disclosure, an inverter 6 can be arranged, and the first signal source 302 and the second signal source 402 can be arranged as the same signal source 7 connected with an input end of the inverter 6, where the pulse signal output from the signal source 7 is applied to the first transistors 301 or the second transistors 401 through the inverter 6.

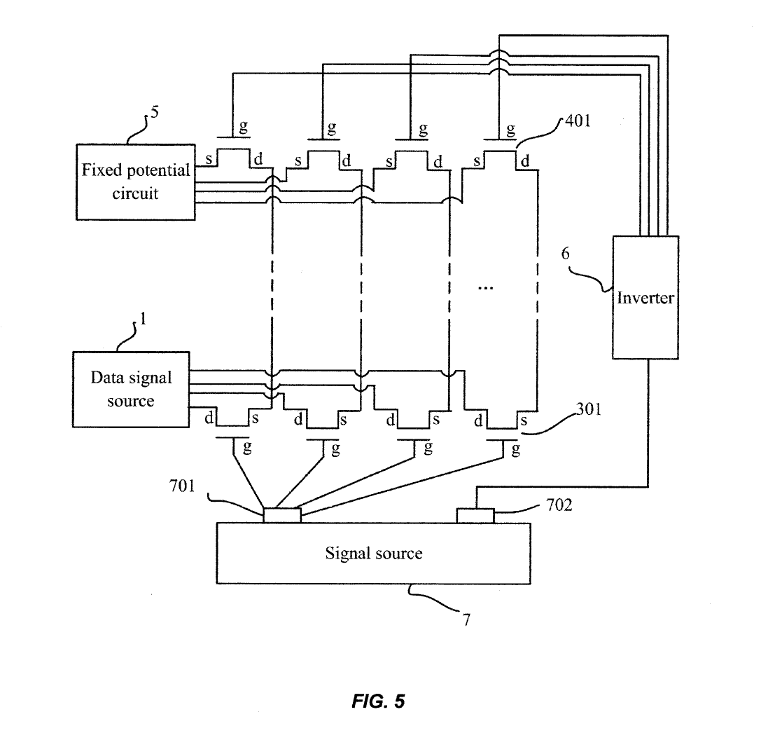

FIG. 5 illustrates a schematic diagram of a control circuit, including an inverter, of a touch display panel according to an embodiment of the disclosure.

In FIG. 5, the signal source 7 includes a first output end 701 and a second output end 702, where the first output end 701 is connected with the gates of the first transistors 301 and applies a first pulse signal to the first transistors 301; and the second output end 702 is connected with an input end of the inverter 6, and the pulse signal output from the signal source 7 passes the inverter 6, and then a second pulse signal opposite in phase to the first pulse signal is obtained and input to the second transistors 401.

It shall be noted that in the embodiment of the disclosure, the signal source 7 is connected with the inverter in FIG. 5 merely by way of an example without any limitation thereto. For example, alternatively the first output end 701 is connected with the gates of the second transistors 401 and applies a first pulse signal to the second transistors 401; and the second output end 702 is connected with an input end of the inverter 6, and the pulse signal output from the signal source 7 passes the inverter 6, and then a second pulse signal opposite in phase to the first pulse signal is obtained and input to the first transistors 301.

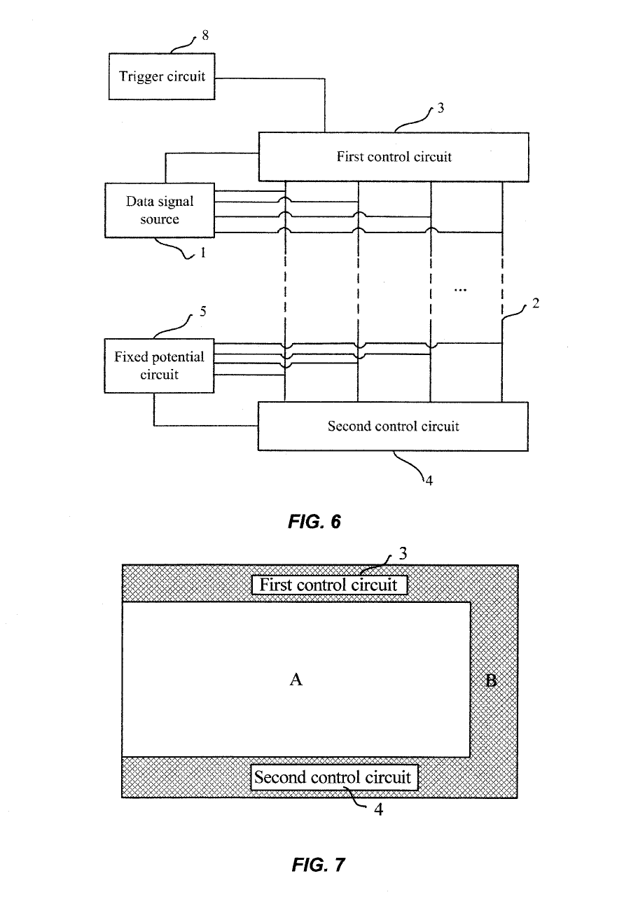

Furthermore in the embodiment of the disclosure, the control circuit of a touch display panel can further include a trigger circuit 8 connected with the first control circuit 3, and FIG. 6 illustrates a schematic diagram of a structure of a control circuit, including a trigger circuit, of a touch display panel according to an embodiment of the disclosure.

In the embodiment of the disclosure, the trigger circuit 8 is configured to trigger the first control circuit 3 to disconnect the data signal lines 2 from the data signal source 1 at the beginning of touch scanning in the touch scan period. The trigger circuit 8 involved in the embodiment of the disclosure can be embodied variously so long as it can perform a trigger function, e.g., a trigger. When there is a need for touch scanning, a pulse signal input to the trigger starts the trigger to trigger the first control circuit 3 to disconnect the data signal lines 2 from the data signal source 1, so that the data signal source 1 stops applying the data signal lines to a display drive signal and touch scanning is performed. The second control circuit 4 can connect the data signal lines 2 with the fixed potential circuit for the purpose of touch scanning

The inverter 6 and the trigger circuit 8 involved in the embodiment of the disclosure can be integrated in an existing integrated circuit of touch display panel without adding any peripheral circuit to the touch display panel. In this way, the circuit design can be simplified.

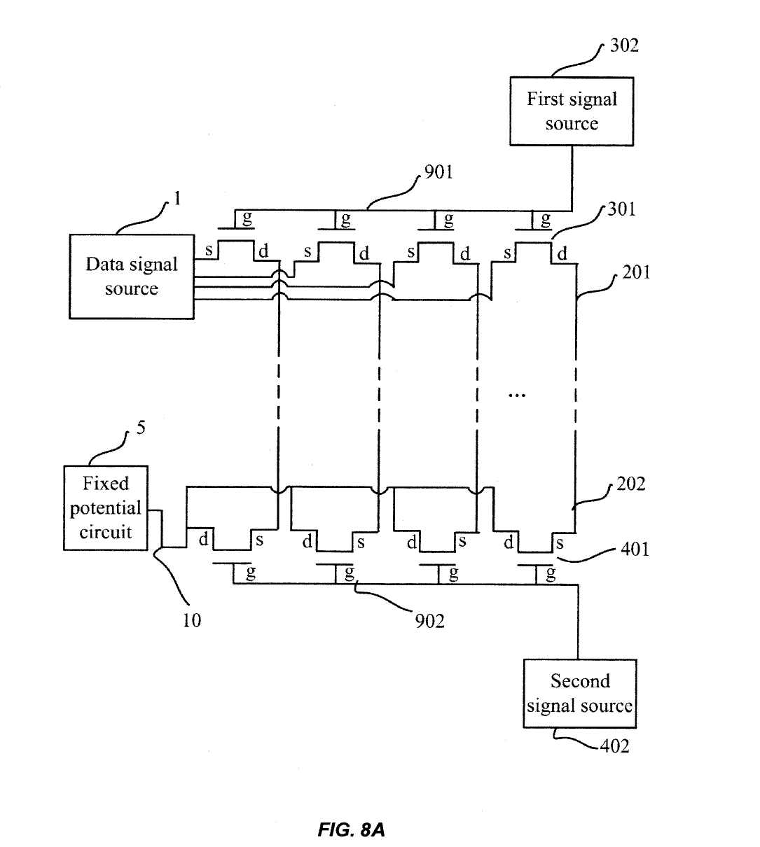

Furthermore the touch display panel includes a display area A and a non-display area B, and in the embodiment of the disclosure, the first control circuit 3 and the second control circuit 4 can be arranged in the non-display area so as not to hinder display by the touch display panel. FIG. 7 is a schematic structural diagram of the touch display panel including the first control circuit 3 and the second control circuit 4 according to the embodiment of the disclosure.

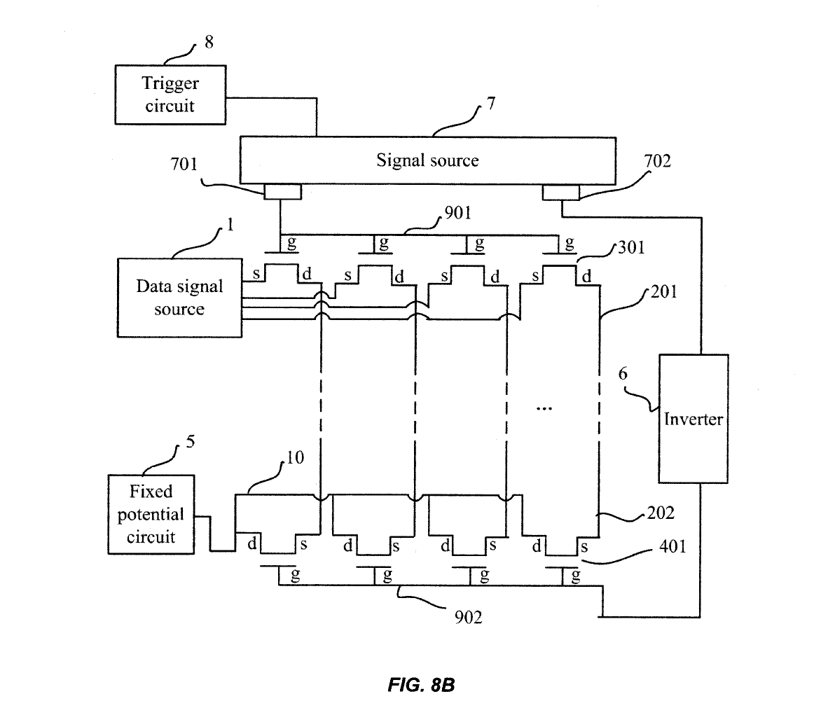

In the embodiment of the disclosure, a circuit structure as illustrated in FIG. 8A is provided to further simplify the circuit design and lower the number of leads, where FIG. 8A illustrates a schematic diagram of a structure of a control circuit of a touch display panel in a simplified circuit structure according to an embodiment of the disclosure. In FIG. 8A, the gates g of several ones of first transistors 301 connected respectively with the respective data lines 2 are electrically connected with the first signal source 302 through a first signal line 901; and the gates g of several ones of second transistors 401 connected respectively with the respective data lines 2 are electrically connected with the second signal source 402 through a second signal line 902.

Furthermore in the embodiment of the disclosure, the drains d of several ones of the second transistors 401 connected respectively with the respective data lines 2 are electrically connected with the fixed potential circuit 5 through a third signal line 10.

FIG. 8B illustrates a schematic diagram of a structure of a control circuit of a touch display panel in a further simplified circuit structure according to an embodiment of the disclosure, and in FIG. 8B, the gates g of several ones of first transistors 301 are connected with the first output end 701 of the signal source 7 through a first signal line 901, the second output end 702 of the signal source 7 is connected with the input end of the inverter 6, and the gates g of several ones of the second transistors 401 are connected with the inverter 6 through a second signal line 902. The pulse signal output from the signal source 7 is applied to the first transistors 301 through the first signal line 901, and the pulse signal output from the signal source 7 passes the inverter 6, and then a second pulse signal opposite in phase to the first pulse signal is obtained and input to the second transistors 401 through the second signal line 902.

In the embodiment of the disclosure, the second control circuit 4 can also function as a switch control circuit to control a display signal to be connected with or disconnected from the touch display panel in a Visible Test (VT). In this way, the circuit design can be further simplified.

Furthermore an embodiment of the disclosure further provides a touch display panel including the control circuit as described above.

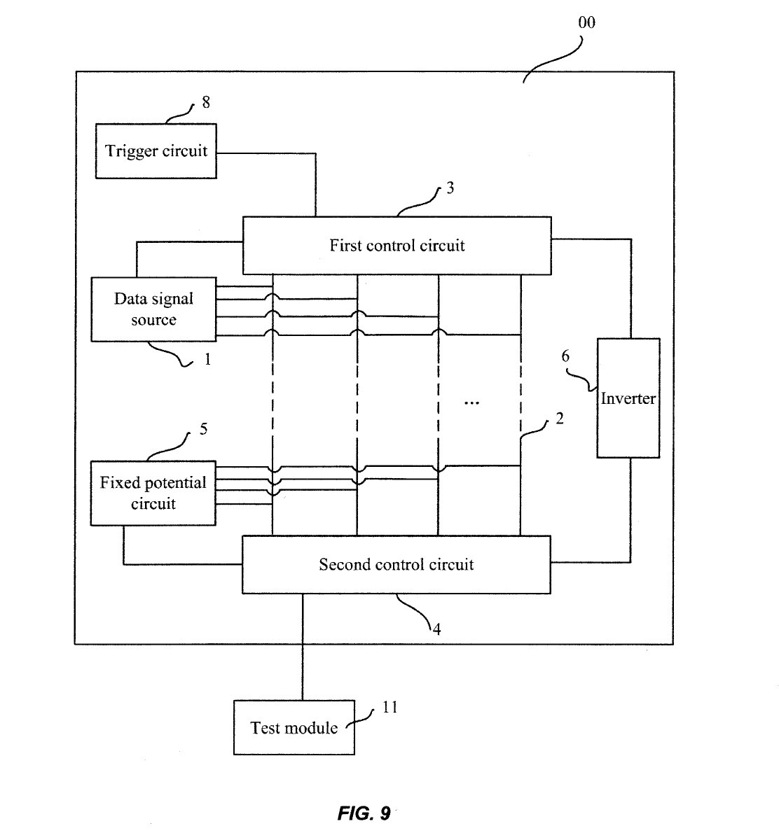

FIG. 9 illustrates a schematic structure diagram of a touch display panel 00 according to an embodiment of the disclosure, where the second control circuit 4 is connected with a test module 11, configured to perform a display test on the touch display panel, and the second control circuit 4 controls a display signal of the test module 11 for a test to be connected with or disconnected from the touch display panel.

It shall be noted that the touch display panel illustrated in FIG. 9 has been structurally illustrated merely by way of an example without any limitation thereto. The control circuit of a touch display panel according to the embodiment of the disclosure is structured as described in the embodiment described above, so a repeated description thereof will be omitted in this embodiment of the disclosure, and reference can be made to the description in the embodiment described above and the relevant drawings.

With the touch display panel and the control circuit thereof according to the embodiments of the disclosure, the first control circuit can control the data signal lines to be connected with or disconnected from the data signal source. In this way, the scan period of the touch display panel may be controlled flexibly by disconnecting the data signal lines from the data signal source in any period in the course of driving one frame of picture for display and instead performing touch scanning, thus desirably prolonging the period for touch scanning, increasing the number of determined touch points and improving the precision at which a touch is determined.

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

What is claimed is:

1. A control circuit of a touch display panel, the control circuit comprising:
a data signal source;
a plurality of data signal lines; and
a first control circuit,
wherein:
a scan period of the touch display panel comprises a display period and a touch scan period,
the first control circuit is configured to connect the data signal lines with the data signal source during the display period, and
the first control circuit is configured to disconnect the data signal lines from the data signal source during the touch scan period.

2. The control circuit according to claim 1, further comprising:
a second control circuit, and
a fixed potential circuit,
wherein:
the second control circuit is configured to disconnect the data signal lines from the fixed potential circuit during the display period, and
the second control circuit is configured to connect the data signal lines with the fixed potential circuit during the touch scan period.

3. The control circuit according to claim 2, wherein:
the first control circuit comprises:
a plurality of first transistors connected respectively with the respective data signal lines, and
a first signal source configured to apply a pulse signal to the first transistors; and
the second control circuit comprises:
a plurality of second transistors connected respectively with the respective data signal lines, and
a second signal source configured to apply a pulse signal to the second transistors; each of the first transistors comprises:
a gate connected with the first signal source,
a source connected with an output end of the data signal source, and
a drain connected with the data signal line proximate to the data signal source; and
each of the second transistors comprises:
a gate connected with the second signal source,
a source connected with a second end of the data signal line, away from the data signal source, and
a drain connected with the fixed potential circuit.

4. The control circuit according to claim 3, further comprising an inverter, wherein:
the first signal source and the second signal source are the same signal source connected with an input end of the inverter, and
the pulse signal output from the signal source is applied to the first transistors or to the second transistors through the inverter.

5. The control circuit according to claim 1, further comprising a trigger circuit connected with the first control circuit, wherein:
the trigger circuit is configured to trigger the first control circuit to disconnect the data signal lines from the data signal source at the beginning of touch scanning in the touch scan period.

6. The control circuit according to claim 3, wherein the touch display panel comprises a display area and a non-display area, and wherein the first control circuit and the second control circuit are disposed in the non-display area.

7. The control circuit according to claim 6, wherein:
the gates of one or more of the first transistors are electrically connected with the first signal source through a first signal line; and
the gates of one or more of the second transistors are electrically connected with the second signal source through a second signal line.

8. The control circuit according to claim 6, wherein the drains of one or more of the second transistors are electrically connected with the fixed potential circuit through a third signal line.

9. The control circuit according to claim 3, wherein the first transistors and the second transistors are low-temperate poly-silicon thin film transistors or oxide thin film transistors.

10. The control circuit according to claim 2, wherein the second control circuit is configured to function as a switch control circuit to control a display signal to be connected with or disconnected from the touch display panel in a Visible Test (VT).

11. A touch display panel, comprising a control circuit comprising:
a data signal source;
a plurality of data signal lines; and
a first control circuit,
wherein:
a scan period of the touch display panel comprises a display period and a touch scan period,
the first control circuit is configured to connect the data signal lines with the data signal source during the display period, and
the first control circuit is configured to disconnect the data signal lines from the data signal source during the touch scan period.
